(19) United States
(12) Patent Application Publication
(10) Pub. No.: US 2002/0003089 A1
(43) Pub. Date: Jan. 10, 2002

(54) Electrophoretic stacking of DNA and other samples prior to electrophoresis

(76) Inventor: James D. DeVault, Sauk City, WI (US)

Correspondence Address: Peter J. Manghera, FOLEY & LARDNER, 150 East Gilman Street, P.O. Box 1497, Madison, WI, 53701-1497, US

(21) Appl. No.: 09/862,653

(22) Filed: May 22, 2001

Related U.S. Application Data
(60) Provisional application No. 60/206,846, filed on May 23, 2000.

(51) Int. Cl. G01N 27/26; G01N 27/447

(52) U.S. Cl. 204/457; 204/456

(57) ABSTRACT

A method of stacking or condensing DNA or other samples prior to electrophoresis to improve electrophoretic resolution. A sample material is placed on a separation medium, e.g., polyacrylamide or agarose gel. A relatively low voltage is applied across the sample for a short period to stack or condense the sample material without significantly transporting the sample material into the separation medium. A large voltage is then applied to inject the stacked sample material into the separation medium.

This application claims the benefit of U.S. Provisional Application No. 60/206,846, filed May 23, 2000.

### FIELD OF THE INVENTION

The present invention pertains generally to methods and devices for performing electrophoretic separation of samples, such as of DNA, and, more particularly, to methods for preparing a sample for electrophoresis

### BACKGROUND OF THE INVENTION

Electrophoresis is the movement of charged molecules in an electric field. It is an important method for the separation of biological molecules because it usually does not affect the native structure of biopolymers and because it is highly sensitive to small differences in both charge and mass. Electrophoresis through a separation medium, such as agarose or polyacrylamide gels, is the standard method used to separate and identify nucleic acid fragments, especially ribonucleic acid (RNA) and deoxyribonucleic acid (DNA) fragments. Detection of nucleic acid fragments is accomplished either in real-time during electrophoresis (known as on-line detection) or after electrophoretic separation has occurred (known as off-line detection) by use of highly sensitive visualization techniques.

The factors affecting the electrophoretic separation of DNA bands in DNA base sequencing are the applied electric field strength, the separation matrix, the column length, and the widths of the individual DNA bands. The latter is determined in large part by the effects of sample diffusion, thermal gradient broadening, detection volume, and the process of injecting the sample into the separation medium prior to electrophoresis. It has been determined that the band broadening generated during the injection process is a significant component of the total width of analyte bands, and thus contributes to the overall separation performance. (See T. Nishikawa & H. Kambara, Analysis of limiting factors of DNA band separation by a DNA sequencer using fluorescent detection, Electrophoresis 12:623-31, 1991.) A mechanism that allows sample bands to load onto a separation device in such a way that the band broadening created by the injection process is minimized would improve the performance of such devices, resulting in greater resolving power.

The key issue in loading samples onto a separation device is the problem of loading a macroscopic sample (1-2 microliters) into a microscopic (nanoliters) sample plug in the separation medium. In a typical DNA sequencing separation, the sample DNA is suspended in 1-2 microliters of solution, and is applied to a region that has a cross-sectional area of approximately 0.075 mm². If there were no stacking forces, the DNA solution would form an injection plug that is 13-26 mm long. This would make resolving different constituents in the sample quite difficult, requiring long separation columns.

Fortunately, some stacking of the sample occurs during a typical injection. For example, the electrophoretic mobility of the DNA sample in the separation medium is significantly less than its mobility in free solution. Therefore, when the DNA leaves the sample solution and enters the separation gel, its velocity decreases causing the DNA to concentrate or stack in the gel. The mobility of DNA in free solution has been previously reported to be 3.3×10⁻⁴ cm²/Vsec. (See N. C. Stellwagen, et al., The free solution mobility of DNA, Biopolymers 42:687-703, 1997.) The mobility of DNA in a polyacrylamide gel varies as a function of DNA size with values ranging from 1×10⁻⁴ cm²/Vsec to 1.8×10⁻⁵ cm²/Vsec. Therefore, mobility differences between free solution and gel can yield a condensing of the sample volume from 1 microliter to 300 nanoliters or less. This condensation is very significant, but not sufficient to obtain high resolution.

Other methods of stacking the DNA sample in the separation medium include manipulating the field strength in the sample solution versus the separation gel by means of a discontinuous buffer system. In one version, the sample is dissolved in a solution of low ionic strength, while the gel contains a solution of higher ionic strength. This results in increased resistance of the sample solution, while current is held constant, so that a relatively higher electric field is applied to the sample solution. Sample molecules will travel more quickly through the region of higher electric field, and slow upon entering the region of lower electric field, resulting in stacking. Yet another method relies on the use of discontinuous buffers to form electric field gradients that focus the sample bands within the separation medium. Other methods involve a brief injection time, such that only a small portion of the sample enters the separation medium, and the rest is wasted. While this method is commonly used, especially for capillary electrophoresis, it has obvious disadvantages in the cost of preparing samples that will not be used.

### SUMMARY OF THE INVENTION

The present invention provides an improved method of stacking or condensing DNA or other samples prior to electrophoresis. In accordance with the present invention, electrophoretic manipulation using a conventional electrophoresis separation device is employed to stack or condense DNA samples in a separation matrix, such as, but not limited to, a polyacrylamide gel. The preferred process involves condensing DNA samples into a small volume prior to subjecting the sample to standard electrophoresis separation procedures. The present invention may be applied to, charged samples other than DNA (biological and/or otherwise), and may be applied prior to injecting or loading onto other separation media used in other electrophoresis techniques (including, but not limited to, capillary electrophoresis and agarose gel electrophoresis).

In accordance with the present invention, a sample material is placed on a separation medium, e.g., in a sample well formed in the medium. A relatively low voltage (e.g., approximately 0.5 V/cm to 15 V/cm) is applied across the sample for a short period (e.g., 10-20 seconds) to stack or condense the sample material in the well without significantly injecting the sample material into the separation medium. A much larger voltage (e.g., 25 V/cm to 200 V/cm) is then applied to inject the stacked sample material into the separation medium in a conventional manner.

Further objects, features, and advantages of the present invention will be apparent from the following detailed description, taken in conjunction with the accompanying drawings.

### BRIEF DESCRIPTION OF THE DRAWINGS

FIG. 1 is a schematic illustration showing one hypothesized effect of low voltage injection of a sample material into a separation medium in accordance with the present invention.

FIG. 2 is a schematic illustration of the effect of stacking injection in accordance with the present invention on DNA bandwidth.

### DETAILED DESCRIPTION OF THE INVENTION

In accordance with the present invention, the voltage applied to inject sample material to be analyzed by electrophoresis into a separation medium is modulated to further focus the sample material. A method in accordance with the present invention may be implemented using a conventional electrophoresis separation device by control of the voltage level provided by the device across a separation medium in which the sample material is placed in a conventional manner. It has been found that when a sample material is injected into a separation medium first for a short period at a low voltage (for instance, 0.5 V/cm to 15 V/cm), followed by injection for a longer period at a high voltage (for instance, 25 V/cm to 200 V/cm), the resulting sample plug width is significantly narrower than that resulting from a conventional fixed voltage injection.

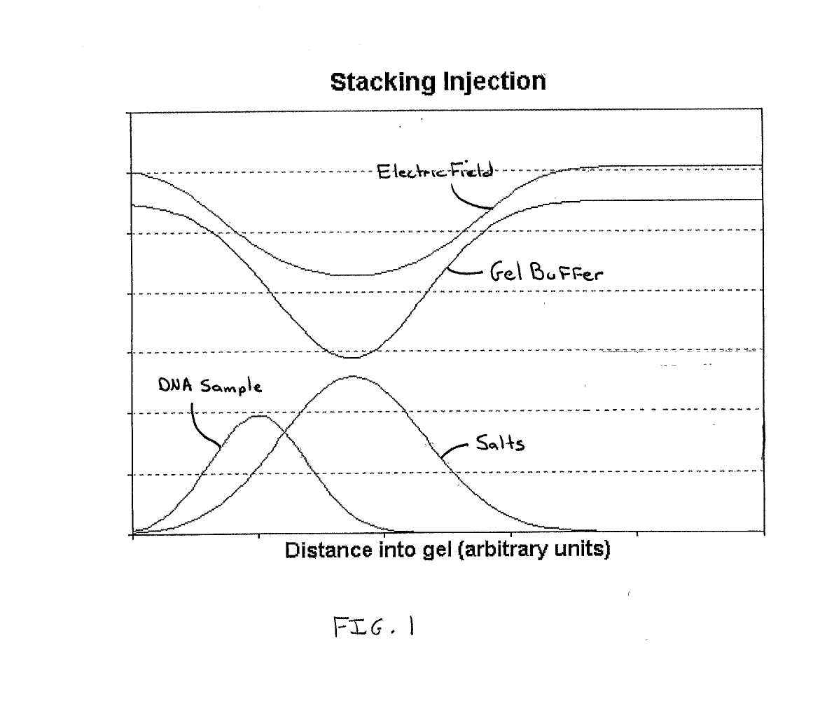

It is hypothesized that this desirable effect may result from one of several possible mechanisms. Most simply, it is possible that the difference in velocity of the analyte molecules between the sample solution and the separation medium is greatest at relatively low voltages. This hypothesis makes intuitive sense, as the velocity of molecules in free solution is fairly linear with respect to voltage, while the velocity of molecules in a sieving separation medium is not linear with respect to voltage. Therefore, there must be an optimum voltage resulting in the largest velocity ratio. Alternatively, it is possible that the low voltage pulse changes the relative velocities of molecules in the two regions during the subsequent high voltage pulse. For instance, competing salts may be removed from the sample solution forming a highly conductive zone in the separation medium in front of the sample. This effect is shown schematically in FIG. 1, wherein salts are illustrated as being driven into a separation gel in front of an exemplary DNA sample, during low voltage stacking injection in accordance with the present invention. This results in a relatively higher electric field strength in the area of the sample and a corresponding lower electric field strength in the separation medium in front of the sample. This, in turn, increases the velocity of analyte molecules in the sample solution and decrease their velocity in the separation medium.

In either case, a high voltage pulse following a low voltage pulse has been found to obtain well-resolved bands. Previous conventional methods for injecting a sample into a separation medium attempt to optimize injection voltage in a single step routine, and thus fail to achieve the advantages of using the low voltage pulse. When conventional single step optimization is done, the necessity of the high-voltage pulse swamps out the benefits of the low-voltage pulse, and the optimum injection condition is found to be at a high voltage. It is only when a two-step procedure in accordance with the present invention is used that the benefits of the low-voltage pulse become clear.

To determine the optimum injection voltage profile, measurements were taken within a sample well during injection to determine the electric field strength that the sample solution experiences. To measure the voltage potential across an individual well, two enamel coated 26 gauge wires were placed in an individual well such that the distance between them was set at 7.6 mm, corresponding to the distance from the top to the bottom of the well. The standard sample well is a 1×2-mm rectangle, resulting in the initial depth of a 1 μl sample of 0.5 mm. A standard 30-cm wtr 5.25% LongRanger polyacrylamide gel was then placed into a BaseStation electrophoresis and analysis device (available from GeneSys Technologies, Inc., Sauk City, Wis.) and the voltage potential across individual wells was determined at various overall injection voltages. Table 1 shows measured well voltages and calculated sample migration distances in 15 seconds.

TABLE 1

| Injection | Actual | Sample |
|---|---|---|
| voltage | voltage | migration (mm) |
| 0 | 0.000 | 0 |
| 25 | 0.605 | 0.039 |
| 50 | 1.045 | 0.068 |
| 100 | 2.28 | 0.148 |
| 200 | 3.3 | 0.215 |
| 250 | 5.3425 | 0.348 |
| 500 | 10.195 | 0.664 |
| 1000 | 20.7 | 1.348 |
| 2500 | 50.6 | 3.296 |
| 5000 | 100.3175 | 6.534 |

A low-voltage pulse in a two-step injection regime thus allows for sample condensation accompanied with little or no migration into the gel matrix. From Table 1 it can be calculated that a 15-second pulse at 200 volts should allow DNA to condense into a decreased sample volume.

Single stranded M13 was sequenced using ABI BigDye termination chemistry and subjected to a pre-injection stacking protocol including a 15-second pulse at 200 volts followed by standardized injection into a denaturing polyacrylamide matrix (5.25%). Stacking and injection was in the presence of water in the cathode chamber and 1×TBE (89 mM tris, 89 mM Borate, 5 mM EDTA) in the gel matrix and anode buffer chamber. Samples were electrophoresed at 2500 volts in a 30-cm well to read format. Specific, predetermined bases from the standard M13 sequence were examined and the distance each entered the gel as a result of the stacking procedure and the injection procedure were measured. Table 2 shows a calculation of migration distances for various sizes of DNA, based on a simplifying assumption that DNA migration rates in a gel matrix are linear with voltage.

TABLE 2

| Base | scan | stack phase | injection phase |
|---|---|---|---|
| 95 | 4491 | 0.116174378 | 8.713078331 |
| 195 | 5747 | 0.090784606 | 6.808845447 |
| 299 | 7238 | 0.072083328 | 5.406249625 |
| 396 | 8372 | 0.062319533 | 4.673964976 |
| 494 | 9617 | 0.054251755 | 4.068881645 |
| 599 | 10991 | 0.047469669 | 3.560225164 |
| 702 | 12132 | 0.043005204 | 3.225390272 |
| 810 | 13299 | 0.039231456 | 2.942359184 |
| 883 | 13977 | 0.037328406 | 2.799630449 |
| 971 | 14809 | 0.03523122 | 2.642341467 |

Table 2 clearly shows that base 95, the fastest moving of those analyzed, is only expected to migrate 0.116 mm into the gel, as a result of the stacking protocol, while the same base is expected to travel 8.713 mm into the polyacrylamide gel matrix following the standard injection procedure (5000 volts for 45 seconds). This suggests that the electrical stacking of DNA samples results in the condensation of the sample, accompanied by little migration into the polyacrylamide gel matrix.

In general, the step of stacking a sample in accordance with the present invention may be performed using any voltage level and duration which stacks or condenses the sample in the sample well while minimizing migration or transport into the separation medium. For example, a voltage level of between approximately 75V to 300V applied for 10 to 20 seconds may achieve the desired result. This voltage level results in a voltage gradient of less than 10 V/cm within the sample volume. Following stacking, the injection step may be performed using any voltage level and duration which injects the stacked sample into the separation medium the desired amount. For example, a voltage level of between approximately 4000V to 5000V applied for 15 to 60 seconds may be employed. This voltage level results in a voltage gradient of greater than 50 V/cm within the sample volume.

A sample condensed in accordance with the present invention will allow for greater electrophoretic resolution. (See T. Nishikawa & H. Kambara, Analysis of limiting factors of DNA band separation by a DNA sequencer using fluorescent detection, Electrophoresis 12:623-31, 1991.) The mathematical basis of band resolution is a function of both bandwidth and band spacing. (See T. D. Yager, et al., High speed DNA sequencing in ultrathin slab gels. Curr. Opinion Biotech. 8:107-113, 1997.) Band separation can be directly influenced by changes in the electrophoretic parameters during a gel run. However, attempts to decrease the bandwidth of a sample below 0.30 mm have either been unsuccessful or not reported. Table 3 presents band width and band separation data following a sample stacking procedure in accordance with the present invention. (A stacking procedure in accordance with the present invention followed by electrophoresis through a 5.5% 30 cm well to read length polyacrylamide gel. Bases refer to specific bases within the standard M13 sequence derived from a BigDye termination reaction with standard—20 primer.) For the first time, a minimal band width measurement of 0.177 mm for a single stranded DNA fragment of 810 bases is observed. This results in a new and improved method for increasing overall sample resolution. (In Table 3 “NM” stands for not measured.)

TABLE 3

| Base | Scan | Scans/base | Band width (mm) | Separation |
|---|---|---|---|---|
| 95 | 5206 | 13 | 0.749 | 0.653 |
| 195 | 6477 | 13 | 0.602 | 0.535 |
| 299 | 7802 | 13 | 0.500 | 0.453 |
| 396 | 9035 | 13 | 0.432 | 0.393 |
| 494 | 10274 | 11 | 0.350 | 0.317 |
| 599 | 11479 | 10 | 0.287 | 0.257 |
| 702 | 12539 | 10 | 0.239 | 0.223 |
| 810 | 13590 | 8 | 0.177 | 0.169 |
| 883 | 14160 | 9 | 0.191 | 0.193 |
| 971 | 14985 | NM | 0.240 | NM |

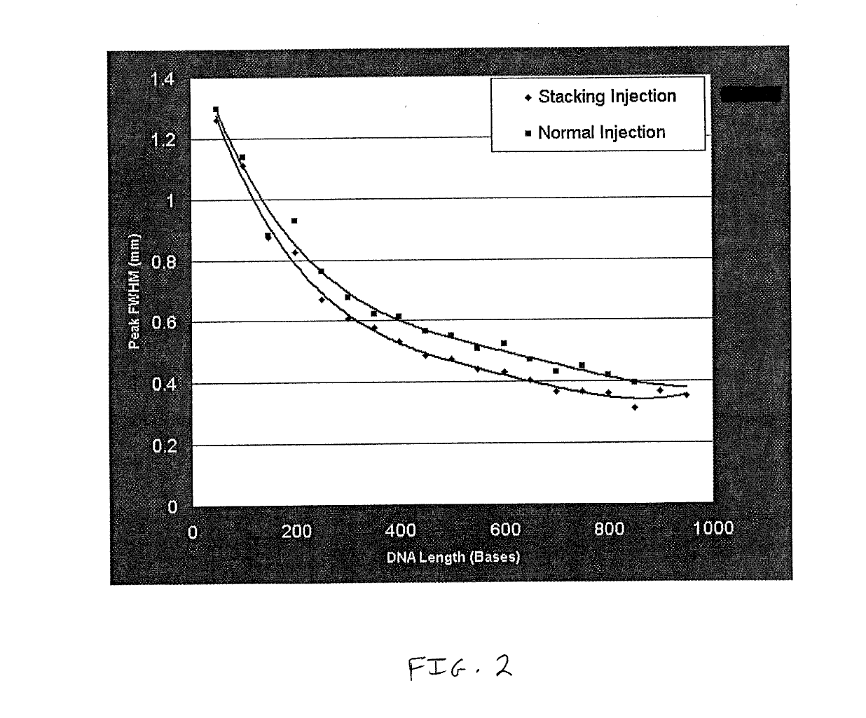

The significance of the sample stacking procedure of the present invention is in its ability to affect directly sample bandwidth, and, therefore, resolution. A schematic illustration of the effect of stacking injection in accordance with the present invention on DNA bandwidth is shown in FIG. 2. Note the decrease in bandwidth as compared to a normal electrophoresis injection procedure not employing low voltage stacking injection in accordance with the present invention. Reduced bandwidth results in a significant increase in overall gel readlength and gel productivity. Sample stacking in accordance with the present invention is a unique, original process that results in increased electrophoretic efficiency.

It should be understood that the present invention is not confined or limited to the particular exemplary embodiments, implementations, and applications described herein, but embraces all such modified forms thereof as come within the scope of the following claims. In particular, it should be noted that the present invention may be employed using any conventional electrophoresis equipment, and in combination with any conventional electrophoresis analysis techniques (including, but not limited to, capillary electrophoresis and agarose gel electrophoresis), and may be applied to any charged samples (biological and/or otherwise) injected or loading onto any separation medium.

What is claimed is:

1. A method for preparing a sample material for electrophoresis, comprising the steps of:
(a) applying a first voltage level for a first duration to the sample material to stack the sample material; and
(b) applying a second voltage level for a second duration to transport the stacked sample material into a separation medium, wherein the second voltage level is greater than the first voltage level.

2. The method of claim 1 wherein the second duration is longer than the first duration.

3. The method of claim 1 comprising additionally the step of placing the sample material on the separation medium before applying the first voltage level.

4. The method of claim 3 wherein the step of applying the first voltage level includes the step of applying a selected first voltage level for a selected first duration to stack the simple material while minimizing transport of the sample material into the separation medium.

5. The method of claim 1 wherein the sample material is biological material.

6. The method of claim 5 wherein the sample material is DNA.

7. The method of claim 1 wherein the separation medium is selected from the group of separation media consisting of polyacrylamide gel and agarose gel.

8. The method of claim 1 wherein the step of applying the first voltage level includes the step of applying a voltage of between approximately 0.5 V/cm and 15 V/cm for a duration of between approximately 10 seconds and 20 seconds.

9. The method of claim 1 wherein the step of applying the second voltage level includes the step of applying a voltage of between approximately 25 V/cm and 200 V/cm for a duration of between approximately 15 seconds and 60 seconds.

10. The method of claim 1 wherein the steps of applying the first voltage level and applying the second voltage level include the steps of controlling an electrophoresis separation device to provide different first and second voltage levels in sequence.
